(19) United States
(12) Patent Application Publication
(10) Pub. No.: US 2022/0408229 A1
(43) Pub. Date: Dec. 22, 2022

(54) LAND MOBILE RADIO AND MISSION CRITICAL PUSH TO TALK INTERWORKING

(71) Applicant: AT&T Intellectual Property I, L.P., Atlanta, GA (US)

(72) Inventors: Xiaoming Zhao, Plano, TX (US); Jerry Shih, Cumming, GA (US)

(21) Appl. No.: 17/501,467

(22) Filed: Oct. 14, 2021

Related U.S. Application Data
(60) Provisional application No. 63/212,556, filed on Jun. 18, 2021.

(51) Int. Cl. H04W 4/10; H04W 4/12; H04W 76/45; H04L 29/06

(52) U.S. Cl. CPC H04W 4/10; H04W 4/12; H04W 76/45; H04L 65/403; H04L 65/4061

(57) ABSTRACT

The disclosed technology is generally directed towards, for interworking function interworking group call services, configuring each of the interworking groups with a separate group home server, with the servers coupled to one another via an interworking function. The interworking function receives a floor taken message from one server, and, in response, obtains a floor grant from the other server, which facilitates communication from a device to which the floor was granted to other devices, including devices associated with the other server. If the interworking function receives colliding floor taken messages from both servers, the interworking function performs mediation to determine which server/user has a higher priority level. The interworking function acknowledges the floor taken message to the higher priority server, and sends a floor request (with high priority) message to the other server, which triggers a floor revoke message to a device on the lower priority side.

### CROSS-REFERENCE TO RELATED APPLICATION

This application is a non-provisional of pending U.S. Provisional Patent Application No. 63/212,556, filed on Jun. 18, 2021 entitled “PRIMARY AND SECONDARY GROUP HOME SERVERS FOR LAND MOBILE RADIO AND MISSION CRITICAL PUSH TO TALK SERVICES.” The entirety of the aforementioned application is hereby incorporated herein by reference.

### TECHNICAL FIELD

The subject application is related to wireless communication systems, and, for example, to interworking services for group calls, such as group calls including land mobile radio and mission critical push-to-talk group call users, and related embodiments.

### BACKGROUND

Third Generation Partnership Project (3GPP) and Project 25 (P25) standards define the specifications for land mobile radio to mission critical push-to-talk interworking functions for land mobile radio users' and mission critical push-to-talk users' interworking services, including group calls and private calls. The 3GPP standard for interworking functions for group calls is not particularly efficient.

More particularly, according to the P25 and 3GPP standards for group calls, a group call server, referred to as the group home server, controls the group call and is assigned/provisioned for each group. If the group home server is on the land mobile radio P25 radio frequency subsystem (RFSS) side, the group home server is referred to as a group home radio frequency subsystem. If the group home server is on the mission critical push-to-talk (MCPTT) system side, the group home server is referred to as a mission critical push-to-talk group control function (CF).

According to the 3GPP standards for land mobile radio user and mission critical push-to-talk user interworking group calls via an interworking function (IWF), if the group home is in the land mobile radio frequency subsystem side, the interworking function performs the control function for the mission critical push-to-talk users in the mission critical push-to-talk system. If instead the group home is in the mission critical push-to-talk system, the interworking function performs the group home radio frequency subsystem system function for the land mobile radio users in the land mobile radio frequency subsystem system.

As the user identifiers (IDs), group IDs, security encryption keys, codecs and the like are different between land mobile radio frequency subsystem and mission critical push-to-talk systems, to support land mobile radio user and mission critical push-to-talk user interworking, the interworking function needs to perform the functions for ID mappings, decryption/encryption, and transcoding for each of the user flows in the interworking group call. Further, because the interworking function acts as both the interworking land mobile radio group home and the interworking mission critical push-to-talk group home (the control function), the interworking function's functional logic is relatively complicated and consumes significant computing power and user flow channeling resources.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system in which group home servers are coupled to one another via an interworking function, in accordance with various aspects and embodiments of the subject disclosure.

FIG. 2 illustrates an example flow of messages and data between a primary group home radio frequency subsystem and a secondary group home push to transmit control function, in accordance with various aspects and embodiments of the subject disclosure.

FIG. 3 illustrates an example flow of messages and data between a primary group home push to transmit control function and a secondary group home radio frequency subsystem, in accordance with various aspects and embodiments of the subject disclosure.

FIG. 4 illustrates an example general block diagram showing group home servers with respective floor request queues, in accordance with various aspects and embodiments of the subject disclosure.

FIG. 5 illustrates an example message flow/message sequence diagram, in which a communication floor is granted to a device for group message transmissions, in accordance with various aspects and embodiments of the subject disclosure.

FIG. 6 illustrates an example message flow/message sequence diagram, in which colliding communication floor taken messages are mediated by an interworking function to grant a communication floor for group message transmissions to only one device, in accordance with various aspects and embodiments of the subject disclosure.

FIG. 7 is a flow diagram showing example operations configuring group home servers coupled together via an interworking function, in accordance with various aspects and embodiments of the subject disclosure.

FIG. 8 is a flow diagram showing example operations of an interworking function, in accordance with various aspects and embodiments of the subject disclosure.

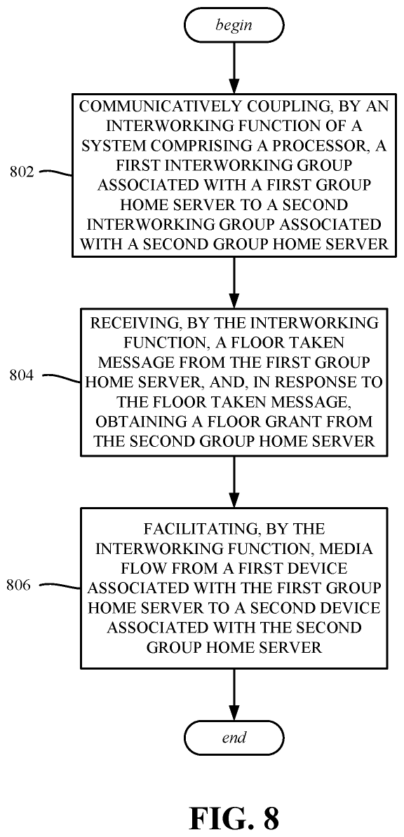

FIG. 9 is a flow diagram showing example operations of a group home server that communicates messages or the like with interworking group device(s) and an interworking function, in accordance with various aspects and embodiments of the subject disclosure.

FIG. 10 illustrates an example block diagram of example user equipment that can be a mobile handset in accordance with various aspects and embodiments of the subject disclosure.

FIG. 11 illustrates an example block diagram of a computer that can be operable to execute processes and methods in accordance with various aspects and embodiments of the subject disclosure.

### DETAILED DESCRIPTION

For interworking function (IWF) interworking group call services, the technology described herein is generally directed towards configuring each of the interworking groups with two group homes, namely a primary group home and a secondary (or equally treated) group home. There is thus one group home on each side, land mobile radio-radio frequency subsystem (LMR-RFSS) and mission critical push-to-talk (MCPTT) side. The primary (or one side) home server controls the group call on its side users and communicates with the secondary (or other side) home server which controls the other side users. In this way the interworking function has no need to act as the group home RFSS function in the LMR system nor act as the group home call control (CF) function in the MCPTT system, as in existing systems. As will be understood, this significantly simplifies and makes more optimal the IWF functional solution.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

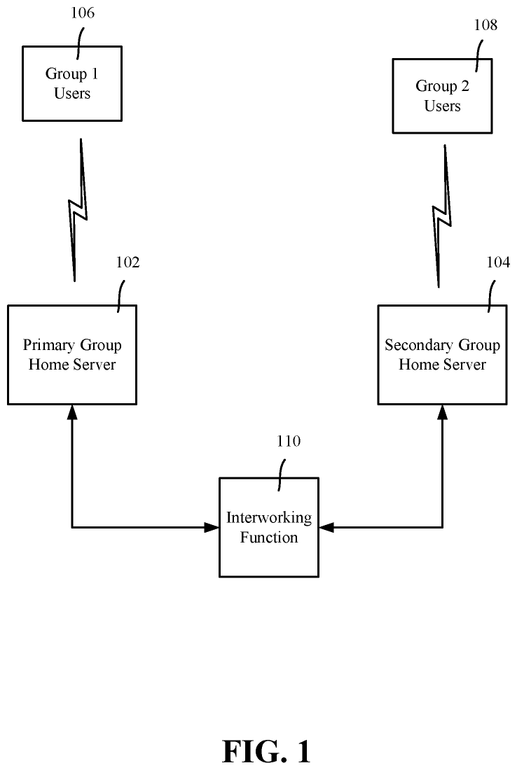

The technology described herein is directed to interworking function interworking group call services, in which each of the interworking groups are configured with a group home server. As represented in FIG. 1, one group home server is referred to as a primary home server 102, and the other group home server is referred to as a secondary home server 104. There is thus a group home server on each side, one on the land mobile radio RF subsystem side and one on the mission critical push-to-talk side. In general, the primary home server 102 controls the group calls and group affiliations for its side's users 106, and communicates with the secondary home server 104, which controls the group calls and group affiliations for the other side's users 108.

The primary group home server 102 can be given priority with respect to floor requests for interworking group calls. Optionally, the two group home servers 102 and 104 can have the same priority level with respect to floor requests for interworking group calls. An interworking function (IWF) 110 plays the role as a serving RF subsystem and participating function (PF), and also mediates the floor request for interworking group calls. As the interworking function 110 does not perform the group home RF subsystem function in the land mobile radio system, nor does the interworking function 110 perform the group home call control (CF) function in the mission critical push to talk system, the IWF functional solution is thus significantly simplified and more optimal.

Note that it is feasible that in alternative implementations, the primary home server 102 can control floor requests for the interworking group calls. In any event, the interworking function 110 has no need to act as the group home RF subsystem function in the land mobile radio system and/or act as the group home call control function in the mission critical push-to-talk system (as in the existing land mobile radio RF subsystem system and mission critical push-to-talk system). Indeed, in any alternative as described herein, the interworking function 110 functional solution is thus significantly simplified and more optimal.

Because there are two separate home servers 102 and 104, floor control needs to be handled between the groups, so that a generally simultaneous request from a land mobile radio system user and a mission critical push-to-talk system user are properly prioritized. One approach to handle the interworking function interworking group floor control is to configure/indicate the primary/secondary group home for each interworking function group in the interworking function 110. That is, the interworking function 110 mediates the floor control requests, based on the group home priority, primary versus secondary, whenever there are contingency floor requests from the group users 106 and 108 in the land mobile radio RF subsystem and mission critical push-to-talk system sides, respectively. The primary and secondary can be predefined, and the primary can always receive priority. The primary and secondary can be predefined, and the primary can always receive priority.

Notwithstanding, both home servers 102 and 104 can have equal priority. Indeed, other mediation alternatives are feasible, e.g., alternating, random, pseudorandom, round-robin, ninety percent primary, ten percent secondary, based on the call initiator, and so on.

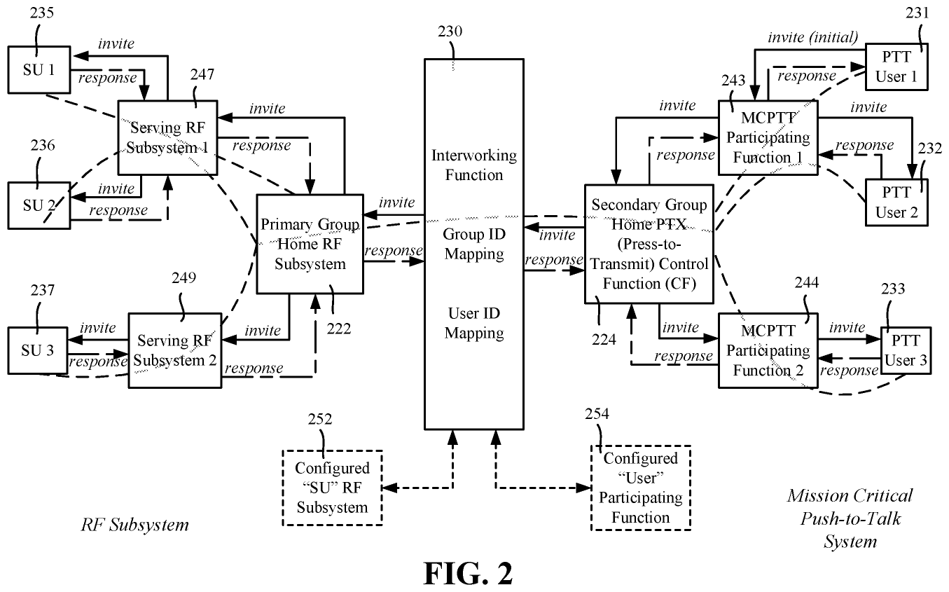

FIG. 2 shows an example of an interworking function group call service flow corresponding to the technology described herein. In this example, the primary group home server 222 is in the RF subsystem system/side, and the secondary group home server 224 is in the mission critical push-to-talk system (also referred to as the push-to-transmit (PTX) system). An interworking function 230 operates between the group home servers 222 and 224 as described herein.

As can be seen, in this example a push-to-talk user 231 initiates the group call. Upon receiving the group invite request, (via a mission critical push-to-talk participating function 243), the secondary home mission critical push-to-talk control function 224 routes/forwards the invite to the primary home RF subsystem 222 via the interworking function 230, as well as to the participating functions 243 and 244 (PFs) of the mission critical push-to-talk users 232 and 233 in the subgroup.

Further, the invite is forwarded by the primary home RF subsystem 222 to its subscriber units (SUs) 235-237 via serving RF subsystems 247 and 249. Once responses are received, media (the curved, dashed lines) can be communicated.

In addition to the group users in the subgroup on each side, the technology described herein configures/affiliates the interworking function 230 as another group user, e.g., the configured subscriber unit 252 in the RF subsystem side and the configured user 254 in the mission n critical push-to-talk system side. In this way, the interworking function 230 acts as if it is a land mobile radio RF subsystem in the RF subsystem side, and a user's participating function in the mission critical push-to-talk system side. That is, the interworking function 230 is provisioned with the association of the interworking function group with the two subgroups in both sides. For interworking function 230 floor control, one subgroup can be indicated / designated as primary, and the other subgroup is indicated secondary, although as described herein, floor control can be mediated, by the interworking function 230, with both group home servers 222 and 224 having the same priority level. In this way, there is not any (or much less) impact to the existing land mobile radio RF subsystem and mission critical push-to-talk systems.

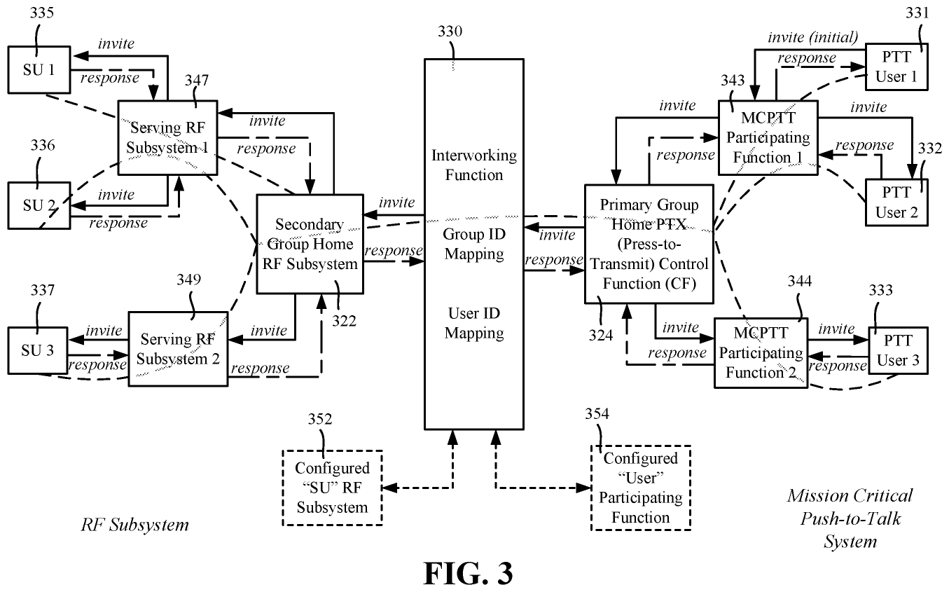

FIG. 3 shows a similar example, except that the primary and secondary group homes are reversed. That is, the mission critical push-to-talk side has the primary group home server 324, and the RF subsystem side has the secondary group home server 322. The communication/dataflow follows a similar pattern to that described with reference to FIG. 2. Although not explicitly shown in FIG. 2 or 3, it is understood that an RF subsystem subscriber unit can initiate a group call in the same general way.

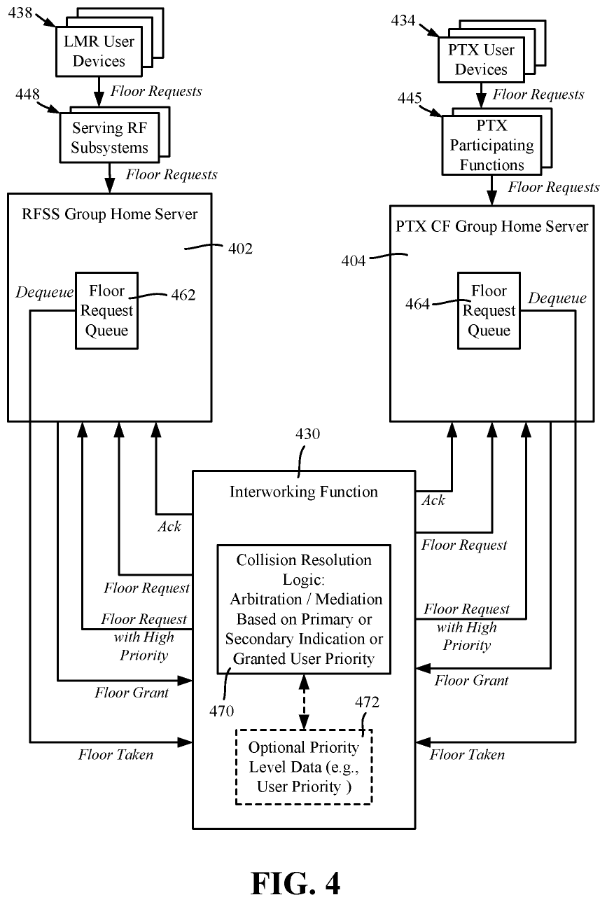

FIG. 4 shows a block diagram in which an RFSS group home server 402 has a floor request queue 462 in which land mobile radio (LMR) user devices (collectively labeled 438) in its interworking group can make requests for communication floor grants to the group home server 402. As described with reference to FIGS. 2 and 3, such requests are via the one or more serving RF subsystems (collectively labeled 448). Similarly, a push to talk/push to transmit (PTX) control function (CF) group home server 404 has a floor request queue 464 in which PTX user devices (collectively labeled 434) can make requests for communication floor grants via one or more PTX participating functions (collectively labeled 445) to the group home server 404. In this example, one of the group home servers can be designated a primary group home server with the other designated a secondary group home server with respect to priority levels, or both can have equal priority levels.

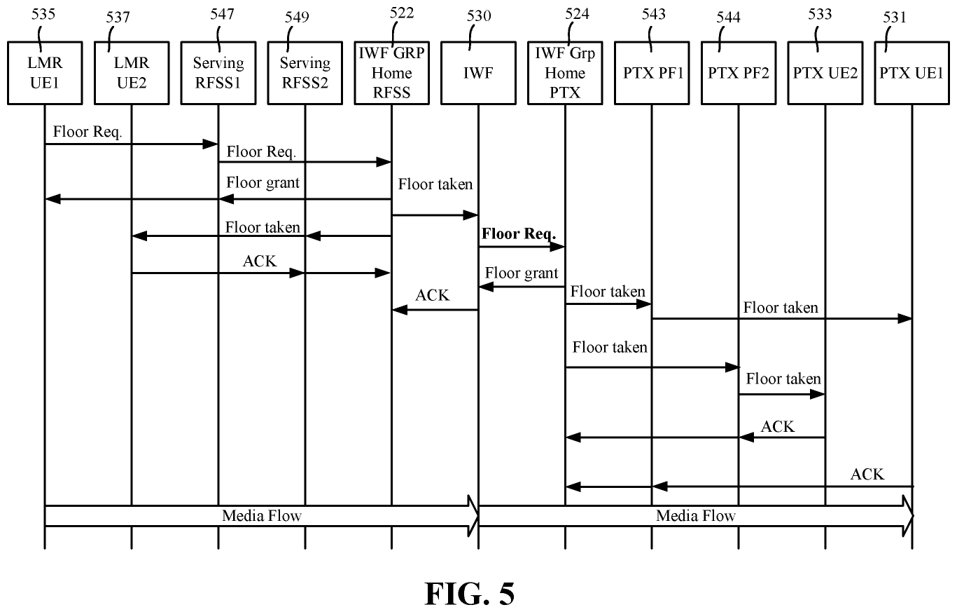

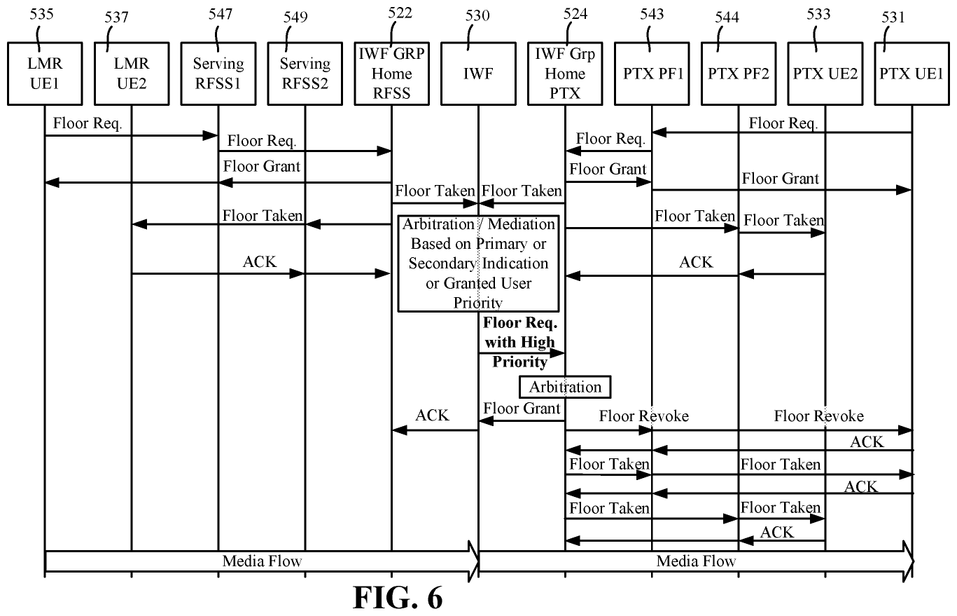

As both homes may independently grant their respective user devices' floor requests, the group home servers queue the floor requests from their respective users when the floor is busy. In this example, there are thus the two queues 462 and 464 managed independently by both group home servers 402 and 404 respectively. Note that it is feasible for a home server to have multiple queues, such as different priority queues for its different users/user devices, can rank requests within a single queue based on priority levels. In any event, once the floor idles each group home server can dequeuer a queued floor request (e.g., from the top of their respective queues) and (via messages as described in FIGS. 5 and 6) grant a communication floor to the corresponding device, while indicating to its other devices, and to the interworking ruction 430, that the communication floor is taken.

Because both home servers 402 and 404 may grant a floor for a user in its respective side at the same time, and send “floor taken” messages to the interworking function 430 to indicate which user is granted the floor in its side, there can be a collision, in which a “floor taken” message from each home server is received simultaneously (or substantially simultaneously, e.g., received at the same time from the interworking function's perspective). To ensure that only one group user from one side can have the floor, the interworking function 430, e.g., via collision resolution logic 470, may convert one of the simultaneously received floor taken messages to a floor request message with high user priority, and send the floor request message to the lower priority side home server, e.g., a secondary server if there is one, or based on another tiebreaking mechanism, such as user/user device priority data 472 known or accessible to the interworking function 430. This triggers the group home server in the lower priority side to revoke the floor granted earlier on its side. The interworking function 430 acknowledges the other floor taken message to the higher priority home server.

FIG. 5 shows an example of a typical message flow sequence between entities, in which a land mobile radio user equipment1 (LMR UE1) 535 sends a floor request (Req.) to its serving radio frequency subsystem (serving RFSS1) 547 for forwarding to the interworking group (GRP) home RFSS 522. In this example, the floor is not taken (or if taken eventually gets granted, e.g., once dequeued) whereby the group home RFSS 522 returns a floor grant message via the serving RFSS1 547 to the LMR UE1 535 to grant the communication floor to the LMR UE1 535. The group home RFSS 522 also sends a floor taken message to the interworking function (IWF) 530, and to the other serving RFSS2 549 for forwarding to its LMR UE2 537; an acknowledgment (ACK) from the LMR UE2 537 is returned on the same path back to the group home RFSS 522.

Upon receipt of the floor taken message, the interworking function 530 sends a floor request message to the PTX group home server 524, which in this example has not granted the communication floor to any of its devices, and thus responds to the interworking function 530 with a floor grant message. When received, the interworking function 530 returns an ACK to the group home RFSS 522.

As can be seen in FIG. 5, based on the floor taken message from the interworking function 530, the group home PTX 524 sends floor taken messages to its PTX user devices 531 and 533 via its PTX participating functions 543 and 544. The devices return ACKs in response to these messages. Media flow through the interworking function 530 then occurs.

Note that although not explicitly shown in the example of FIG. 5, it is understood that any device can request the communication floor, with corresponding messages sent between the entities involved. Thus, for example, (instead of the floor grant to the LMR UE1 535), the communication floor can be granted to the LMR UE2 537, to the PTX UE1 531, or to the PTX UE1 533, with suitable floor taken messages sent to the other devices to which the floor was not granted.

FIG. 6 shows a message flow sequence in which both sides simultaneously send a floor taken message to the interworking function 530. As can be readily understood from the message flow described with reference to FIG. 5, each side operates in the same way to grant a floor to its requesting device, and indicate the floor is taken to its other devices.

However, in FIG. 6, because of the simultaneous floor taken messages, the interworking function 530 needs to arbitrate/mediate which side will be granted the communication floor. In this example, based on a primary or secondary indication of each side (if any), granted user priority, or some other tiebreaking mechanism, the interworking function 530 decides that the LMR-RFSS side is to be granted the floor, and not the PTX side.

Thus, as shown in FIG. 6, the interworking function 530 sends a “floor request with high priority” message to the PTX group home server 524, which responds with a floor grant message. When received, the interworking function 530 grants the floor via an ACK to the RFSS group home server 522.

The “floor request with high priority” message triggers the PTX group home server 524 to send a floor revoke message to the device 531 (via its participating function 543) to which the floor was previously (temporarily) granted, and send floor taken messages to its other device(s). The device from which the floor was revoked can be re-queued, e.g., at the top of the queue; (this can be accomplished by not fully dequeuing the floor request until acknowledged by the interworking function 530), e.g., flagging the request as ‘pending dequeue’ until acknowledged and actually dequeued, or changing the state back to queued if revoked). Each device acknowledges its received message, that is, that the floor is revoked or taken. Media flow from the LMR UE1 535 (the device to which the communication floor has been granted) then occurs.

To summarize, an approach to handle the IWF interworking group floor control is to configure/indicate a primary/secondary group home for each IWF groups in the IWF, whereby the interworking function 530 mediates the floor control requests based on the group home priority i.e. primary vs. secondary, and/or by the mapped user priorities for the IWF group users on both sides, if there are contingency floor requests from the group users in the both LMR-RFSS and MCPTT system sides. In a non-collision scenario, either side's group home server grants the floor for a group user floor request and sends floor taken message to other group users. For two group home group floor controls, one group converts the floor taken message received from one side to a floor request message and sends it to the other side, whereby the other side group home server grants the request.

In a collision scenario, because both homes may grant a floor for a user in its side at the same time and send floor taken messages to the interworking function 530 to indicate which user is granted for the floor in its side, to ensure only one group user can have the floor, the interworking function 530 may convert one of the floor taken messages received simultaneously to a floor request message with high user priority and send it to the lower priority side home server. This triggers the group home server on the lower priority side to revoke the floor granted earlier in its side as shown in the example of FIG. 6.

Note that if for any reason, a floor revoke does not happen, a dual floor call session results. This is generally acceptable, service-wise.

In a two group home IWF interworking architecture as described herein, the interworking function acts as a super-serving RFSS for a LMR user, and as a super-primary function for an MCPTT user for IWF group and private calls. The following sets for example information that can be used to make an interworking function as a serving RFSS and a primary function. Note that the interworking function is provisioned in the existing RFSS system and MCPTT system with a serving RFSS ID and a PF MCPTT server ID, respectively.

For IWF group calls, the IDs of the IWF groups and the group users are provisioned in the existing RFSS and MCPTT systems. Each IWF group ID is provisioned with a group home RFSS ID and a group home MCPTT CF (control function) ID in each system. The interworking function stores the IWF group IDs associated with the two Home IDs in the two system sides. Each home ID is associated with a user ID that the interworking function is acting as.

| IWF Grp | RFSS Grp | RFSS Grp | MCPTT Grp | MCPTT Grp |
|---|---|---|---|---|
| No | Home ID | User ID | CF ID | User ID |
| IWF Grp 1 | SD SG 1 | IWF SG 1 | MCPTT Grp 1 | IWF Grp 1 |
| ID | Home ID | SD ID | CF ID | PTT User ID |
| IWF Grp 2 | SD SG 2 | IWF SG 2 | MCPTT Grp 2 | IWF Grp 2 |
| ID | Home ID | SD ID | CF ID | PTT User ID |
| . . . | . . . | . . . | . . . | . . . |
| IWF Grp n | SD SG n | IWF SG n | MCPTT Grp n | IWF Grp n |
| ID | Home ID | SD ID | CF ID | PTT User ID |

At IWF service activation, the interworking function acting as serving RFSSs and PFs for these IWF groups send registration messages on behalf of each of the group users (that the interworking function is operating as) to the corresponding home servers. In this way the interworking function starts to act as the RFSS and PF functions of the pseudo-users for the IWF groups provisioned in the interworking function.

For IWF private calls, the IWF private call user IDs are provisioned in the existing RFSS and MCPTT systems. In the interworking function, each IWF private call user ID in a system has a user ID mapping in the other system, and also has a preconfigured serving RFSS for LMR users or a participating function for MCPTT users.

| IWF LMR | Mapped PTT | IWF MCPTT | Mapped LMR |
|---|---|---|---|
| UlDs | UlDs | UIDs | UIDs |
| SD 1 | Mapped PTT lD 1 | MCPTT ID 1 | Mapped SD 1 |
| SD 2 | Mapped PTT lD 2 | MCPTT ID 2 | Mapped SD 2 |
| . . . | . . . | . . . | . . . |
| SD n | Mapped PTT lD n | MCPTT ID m | Mapped SD n |

At IWF service activation, the interworking function acting as serving RFSSs and PFs for these private IWF users send a registration message on behalf of each of the IWF private call users (that the interworking function acts as) to the other system side. In this way the interworking function starts to act as the pseudo-RFSS and pseudo-PF functions of the IWF private call users provisioned in the interworking function.

It should be noted that a primary group home server may communicate (e.g., media) with a secondary group home server. However, such a media flow from the primary home server to the secondary home server may not be needed if the media flow is from the secondary home side and delivered to primary group home via the interworking function. Further, the group primary home/secondary home need not be named/provisioned, as for an interworking function group, two subgroups are provisioned according to the technology described herein, with one subgroup being the in land mobile radio RF subsystem system and the other subgroup being the mission critical push-to-talk system, as current.

Unlike the 3GPP design, in which the interworking function design has the interworking function needing the participating function information as well as performing any encryption/transcoding for the multiple mission critical push-to-talk users, the participating function information remains on the mission critical push-to-talk side.

Thus, for example, to use an existing mission critical push-to-talk server as the secondary (or the non-home side) group home server control function, the mission critical push-to-talk users of the interworking function group publish their participating function information to the secondary home in the mission critical push-to-talk system when doing registrations. The secondary home control function stores the published group user registration or deregistration information in real time as current.

When a mission critical push-to-talk user initiates the interworking function group call, the mission critical push-to-talk user sends invite from the mission critical push-to-talk user participating function to the secondary home (or control function). Upon receiving the group invite, the secondary home mission critical push-to-talk control function routes/forwards the invite to the primary home RF subsystem via the interworking function, and also to the participating functions of the mission critical push-to-talk users in the group. Note that between the interworking function and the mission critical push-to-talk system (interworking function group mission critical push-to-talk control function) there is one signaling flow and one media flow; there is no need for the interworking function to get the participating function information for the interworking function group mission critical push-to-talk users, and similarly no need for the interworking function to set up connectivity with the mission critical push-to-talk user participating functions.

This provides a significant benefit, which can be estimated from the interworking function service flow number comparison. For example, let K=N+M, where K=the total interworking function group members, N=the number of interworking function group users in the home or primary home side, n=number of interworking function serving RF subsystems; (1<n<number of land mobile radio users of the interworking group) and M=the number of interworking function group users in the non-home or secondary home side.

Estimates are that the using the technology described herein, the real time interworking function processing time and channel resource utilization could be reduced to 1/M or 1/N or 1/n. As a practical example using an interworking call model profile with 100 users per interworking function group, with half being land mobile radio users and half being mission critical push-to-talk users (N=M=50), the real time interworking function processing time and channel resource utilization can be reduced to 1/50, or two percent of the processing time and interworking function channel resource relative to the 3GPP interworking function specification approach. Such significant benefits are achieved based on configuration/provisioning of the interworking function interworking group with a primary home server and a secondary home server, which bypass the group home RF subsystem function and the group control function (CF) function on the interworking function.

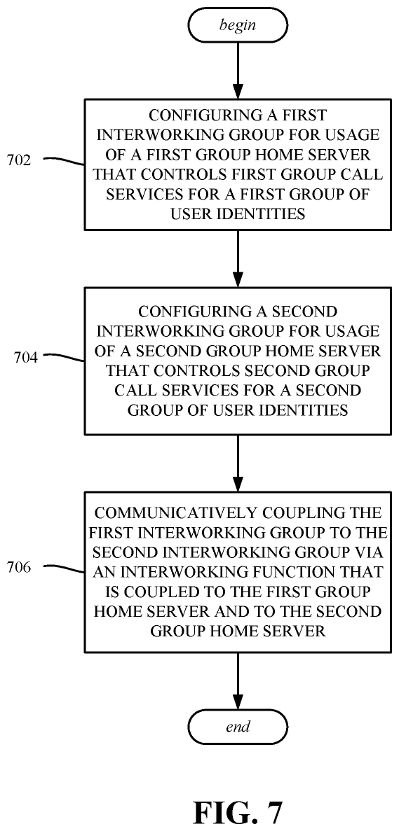

One or more aspects are represented in FIG. 7, and can comprise example operations, such as of a method, or a processor and a memory that stores executable instructions and/or components that, when executed by the processor, facilitate performance of the example operations, or a machine-readable medium, comprising executable instructions that, when executed by a processor, facilitate performance of the example operations. Operation 702 represents configuring a first interworking group for usage of a first group home server that controls first group call services for a first group of user identities. Operation 704 represents configuring a second interworking group for usage of a second group home server that controls second group call services for a second group of user identities. Operation 706 represents communicatively coupling the first interworking group to the second interworking group via an interworking function that is coupled to the first group home server and to the second group home server.

The first group home server can include a primary group home server and the second group home server can include a secondary group home server, and the interworking function can acknowledge the first floor taken message based on the first group home server comprising the primary group home server, and can send a floor request with a high priority message to the second group home server, based on the second group home server comprising the secondary group home server, to trigger a floor revoke message that revokes a floor grant to a device coupled to the secondary group home server.

The interworking function can receive a first floor taken message from the first group home server simultaneously or substantially simultaneously with a second floor taken message from the second group home server, and the interworking function, based on user priority data, can acknowledge the first floor taken message to the first group home server, and can send a floor request with a high priority message to the second group home server to trigger a floor revoke message that revokes a floor grant to a device coupled to the secondary group home server.

The first home server can comprise a radio frequency subsystem and the second home server can comprise a push-to-transmit control function. Further operations can include configuring the interworking function to act as a serving radio frequency subsystem of the first interworking group, and configuring the interworking function as a push-to-talk participating function of the second interworking group. The first group home server can be coupled to a land mobile radio user device via a serving radio frequency subsystem, and the second group home server can be coupled to a push-to-talk user device via a push-to-talk participating function.

The first home server can comprise a push-to-transmit control function, and the second home server can comprise a radio frequency subsystem. Further operations can include configuring the interworking function as a push-to-talk participating function of the first interworking group, and configuring the interworking function to act as a serving radio frequency subsystem of the second interworking group. The first group home server can be coupled to a push-to-talk user device via a push-to-talk participating function, and the second group home server can be coupled to a land mobile radio user device via a serving radio frequency subsystem.

One or more aspects are represented in FIG. 7, and can comprise example operations, such as of a method, or a processor and a memory that stores executable instructions and/or components that, when executed by the processor, facilitate performance of the example operations, or a machine-readable medium, comprising executable instructions that, when executed by a processor, facilitate performance of the example operations. Operation 802 represents communicatively coupling, by an interworking function of a system comprising a processor, a first interworking group associated with a first group home server to a second interworking group associated with a second group home server. Operation 804 represents receiving, by the interworking function, a floor taken message from the first group home server, and, in response to the floor taken message, obtaining a floor grant from the second group home server. Operation 806 represents facilitating, by the interworking function, media flow from a first device associated with the first group home server to a second device associated with the second group home server.

Facilitating the media flow can include acknowledging the floor taken message to the first group home server.

Obtaining the floor grant from the second group home server can include sending a floor request message to the second group home server.

Obtaining the floor grant from the second group home server can include sending a floor request message with high priority to the second group home server.

The floor taken message from the first group home server can be a first floor taken message, and further operations can include receiving, by the interworking function, a second floor taken message from the second group home server simultaneously or substantially simultaneously with the receiving the first floor taken message, and, in response to the second floor taken message, mediating the first floor message and the second floor message to determine that the first floor message is associated with a higher priority level than the second floor message; obtaining the floor grant from the second group home server can include sending a floor request message with a designated high priority to the second group home server. Mediating the first floor message and the second floor message to determine that the first floor message is associated with the higher priority level can include determining that the first group home server has a higher priority level than a lower priority level of the second group home server. Mediating the first floor message and the second floor message to determine that the first floor message is associated with a higher priority level can include determining, based on mapped user priority data, that a first user identity associated with the first device has a higher priority level than a lower priority level of a second user identity associated with the second device.

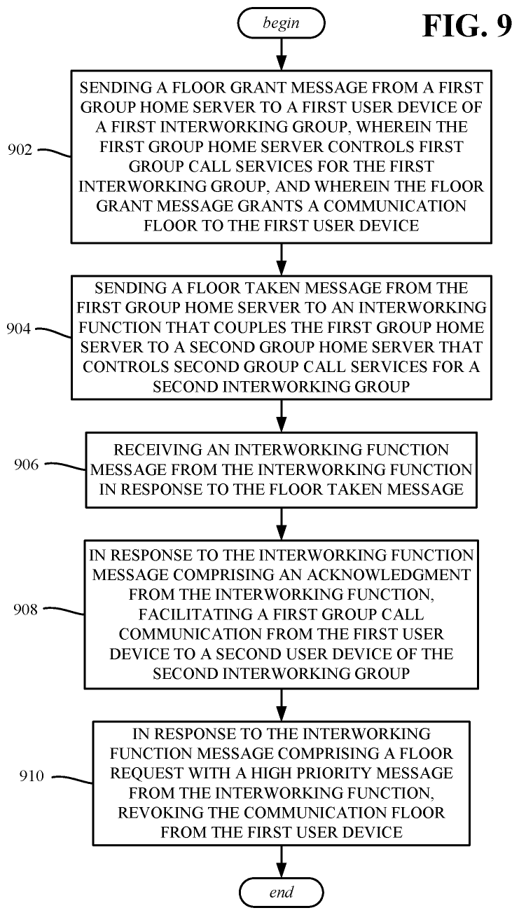

One or more aspects are represented in FIG. 9, and can comprise example operations, such as of a method, or a processor and a memory that stores executable instructions and/or components that, when executed by the processor, facilitate performance of the example operations, or a machine-readable medium, comprising executable instructions that, when executed by a processor, facilitate performance of the example operations. Operation 902 represents sending a floor grant message from a first group home server to a first user device of a first interworking group, wherein the first group home server controls first group call services for the first interworking group, and wherein the floor grant message grants a communication floor to the first user device. Operation 904 represents sending a floor taken message from the first group home server to an interworking function that couples the first group home server to a second group home server that controls second group call services for a second interworking group. Operation 906 represents receiving an interworking function message from the interworking function in response to the floor taken message. Operation 908 represents in response to the interworking function message comprising an acknowledgment from the interworking function, facilitating a first group call communication from the first user device to a second user device of the second interworking group. Operation 910 represents in response to the interworking function message comprising a floor request with a high priority message from the interworking function, revoking the communication floor from the first user device.

Further operations can include queuing, by the first group home server, a first floor request from the first user device, queuing, by the first group home server, a second floor request from a third user device of the first interworking group, and wherein the sending of the floor grant message and the sending the floor taken message occurs in response to dequeuing the first floor request.

The interworking function message can comprise the floor request with a high priority message, and further operations can include re-queuing the first floor request.

The floor taken message can be a first floor taken message, the interworking function message can comprise the floor request with a high priority message, and further operations can include sending a second floor taken message from the first group home server to a serving subsystem or a participating function coupled to the first group home server.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

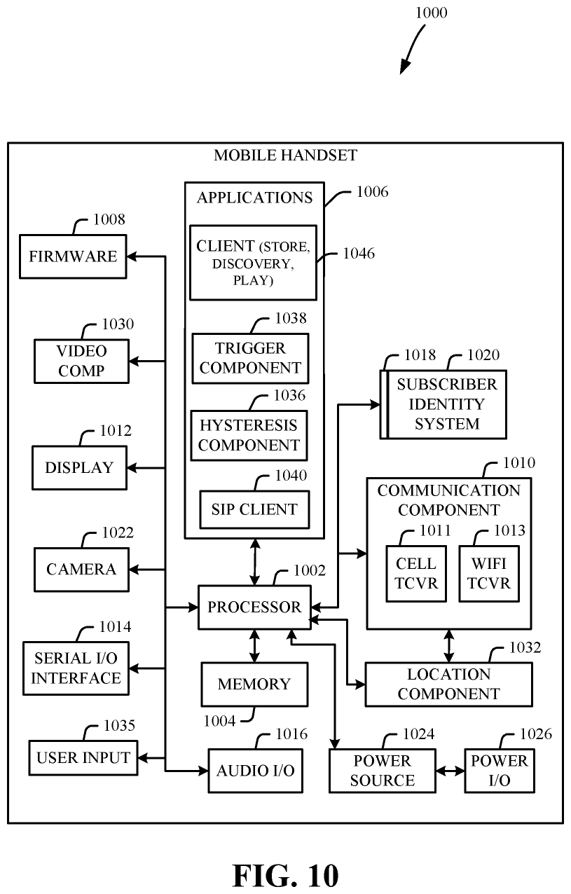

Referring now to FIG. 10, illustrated is a schematic block diagram of an example end-user device such as a user equipment) that can be a mobile device 1000 capable of connecting to a network in accordance with some embodiments described herein. Although a mobile handset 1000 is illustrated herein, it will be understood that other devices can be a mobile device, and that the mobile handset 1000 is merely illustrated to provide context for the embodiments of the various embodiments described herein. The following discussion is intended to provide a brief, general description of an example of a suitable environment 1000 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1000 includes a processor 1002 for controlling and processing all onboard operations and functions. A memory 1004 interfaces to the processor 1002 for storage of data and one or more applications 1006 (e.g., a video player software, user feedback component software, etc.). Other applications can include voice recognition of predetermined voice commands that facilitate initiation of the user feedback signals. The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and/or an unlicensed transceiver 1013 (e.g., Wi-Fi, WiMax) for corresponding signal communications. The handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of video quotes. A serial I/O interface 1014 is provided in communication with the processor 1002 to facilitate wired and/or wireless serial communications (e.g., USB, and/or IEEE 1094) through a hardwire connection, and other serial input devices (e.g., a keyboard, keypad, and mouse). This supports updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process IP data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1022 (e.g., a camera) can be provided for decoding encoded multimedia content. The video processing component 1022 can aid in facilitating the generation, editing and sharing of video quotes. The handset 1000 also includes a power source 1024 in the form of batteries and/or an AC power subsystem, which power source 1024 can interface to an external power system or charging equipment (not shown) by a power I/O component 1026.

The handset 1000 can also include a video component 1030 for processing video content received and, for recording and transmitting video content. For example, the video component 1030 can facilitate the generation, editing and sharing of video quotes. A location tracking component 1032 facilitates geographically locating the handset 1000. As described hereinabove, this can occur when the user initiates the feedback signal automatically or manually. A user input component 1034 facilitates the user initiating the quality feedback signal. The user input component 1034 can also facilitate the generation, editing and sharing of video quotes. The user input component 1034 can include such conventional input device technologies such as a keypad, keyboard, mouse, stylus pen, and/or touch screen, for example.

Referring again to the applications 1006, a hysteresis component 1036 facilitates the analysis and processing of hysteresis data, which is utilized to determine when to associate with the access point. A software trigger component 1038 can be provided that facilitates triggering of the hysteresis component 1038 when the Wi-Fi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

The handset 1000, as indicated above related to the communications component 810, includes an indoor network radio transceiver 1013 (e.g., Wi-Fi transceiver). This function supports the indoor radio link, such as IEEE 802.11, for the dual-mode GSM handset 1000. The handset 1000 can accommodate at least satellite radio services through a handset that can combine wireless voice and digital radio chipsets into a single handheld device.

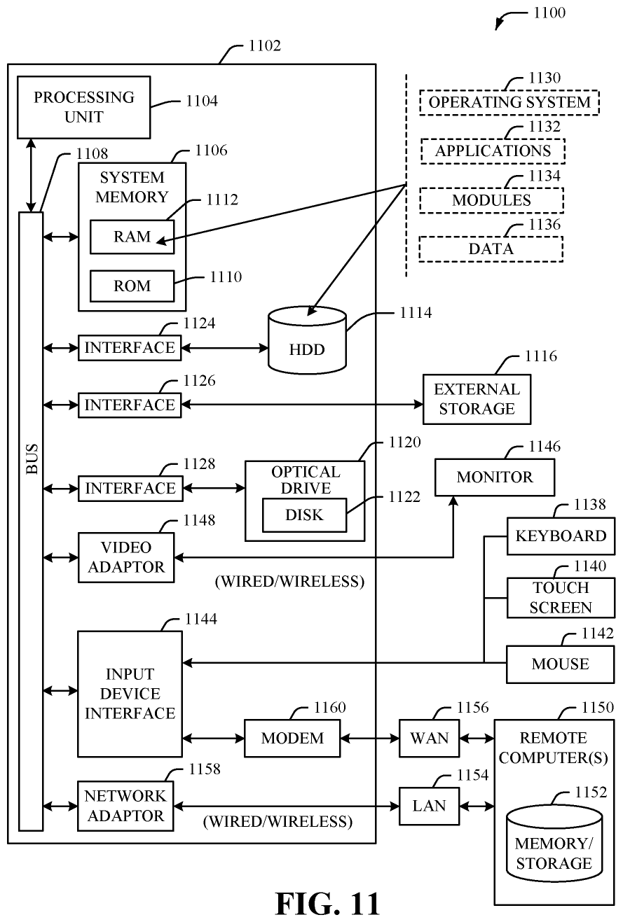

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD), non-volatile memory and other storage technology could be used in addition to, or in place of, an HDD 1114, and can be internal or external. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally include emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can include one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1094 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 11 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions which, when executed by the processor of the system, facilitate performance of operations, the operations comprising:
configuring a first interworking group for usage of a first group home server that controls first group call services for a first group of user identities;
configuring a second interworking group for usage of a second group home server that controls second group call services for a second group of user identities; and
communicatively coupling the first interworking group to the second interworking group via an interworking function that is coupled to the first group home server and to the second group home server.

2. The system of claim 1, wherein the first group home server comprises a primary group home server and the second group home server comprises a secondary group home server, and wherein the interworking function acknowledges the first floor taken message based on the first group home server comprising the primary group home server, and sends a floor request with a high priority message to the second group home server, based on the second group home server comprising the secondary group home server, to trigger a floor revoke message that revokes a floor grant to a device coupled to the secondary group home server.

3. The system of claim 1, wherein the interworking function receives a first floor taken message from the first group home server simultaneously or substantially simultaneously with a second floor taken message from the second group home server, and wherein the interworking function, based on user priority data, acknowledges the first floor taken message to the first group home server, and sends a floor request with a high priority message to the second group home server to trigger a floor revoke message that revokes a floor grant to a device coupled to the secondary group home server.

4. The system of claim 1, wherein the first home server comprises a radio frequency subsystem and the second home server comprises a push-to-transmit control function.

5. The system of claim 4, wherein the operations further comprise configuring the interworking function to act as a first pseudo-user and a serving radio frequency subsystem of the pseudo user of the first interworking group, configuring the interworking function as a second pseudo user and the push-to-talk participating function of the pseudo-user of the second interworking group, and wherein on behalf of the first pseudo-user, the interworking function forwards the call setup, media flows and call termination received from the first interworking group to the second interworking group, or on behalf of the second pseudo-user, the interworking function forwards the call setup, media flows and call termination received from the second interworking group to the first interworking group.

6. The system of claim 4, wherein the first group home server is coupled to a land mobile radio user device via a serving radio frequency subsystem, and wherein the second group home server is coupled to a push-to-talk user device via a push-to-talk participating function.

7. The system of claim 1, wherein the first home server comprises a push-to-transmit control function, and wherein the second home server comprises a radio frequency subsystem.

8. The system of claim 7, wherein the operations further comprise configuring the interworking function as a first pseudo-user and the push-to-talk participating function of the first pseudo-user of the first interworking group, configuring the interworking function to act as a second pseudo-user and the serving radio frequency subsystem of the second pseudo-user of the second interworking group, and wherein on behalf of the first pseudo-user, the interworking function forwards the call setup, media flows and call termination received from the first interworking group to the second interworking group, or on behalf of the second pseudo-user, the interworking function forwards the call setup, media flows and call termination received from the second interworking group to the first interworking group.

9. The system of claim 7, wherein the first group home server is coupled to a push-to-talk user device via a push-to-talk participating function, and wherein the second group home server is coupled to a land mobile radio user device via a serving radio frequency subsystem.

10. A method, comprising:
communicatively coupling, by an interworking function of a system comprising a processor, a first interworking group associated with a first group home server to a second interworking group associated with a second group home server;
receiving, by the interworking function, a floor taken message from the first group home server, and, in response to the floor taken message, obtaining a floor grant from the second group home server; and
facilitating, by the interworking function, media flow from a first device associated with the first group home server to a second device associated with the second group home server.

11. The method of claim 10, wherein the facilitating of the media flow comprises acknowledging the floor taken message to the first group home server.

12. The method of claim 10, wherein the obtaining of the floor grant from the second group home server comprises sending a floor request message to the second group home server.

13. The method of claim 10, wherein the obtaining of the floor grant from the second group home server comprises sending a floor request message with high priority to the second group home server.

14. The method of claim 10, wherein the floor taken message from the first group home server is a first floor taken message, and wherein the method further comprises receiving, by the interworking function, a second floor taken message from the second group home server simultaneously or substantially simultaneously with the receiving the first floor taken message, and, in response to the second floor taken message, mediating the first floor message and the second floor message to determine that the first floor message is associated with a higher priority level than the second floor message, and wherein the obtaining of the floor grant from the second group home server comprises sending a floor request message with a designated high priority to the second group home server.

15. The method of claim 14, wherein the mediating of the first floor message and the second floor message to determine that the first floor message is associated with the higher priority level comprises determining that the first group home server has a higher priority level than a lower priority level of the second group home server.

16. The method of claim 14, wherein the mediating of the first floor message and the second floor message to determine that the first floor message is associated with a higher priority level comprises determining, based on mapped user priority data, that a first user identity associated with the first device has a higher priority level than a lower priority level of a second user identity associated with the second device.

17. A non-transitory machine-readable medium, comprising executable instructions that, when executed by a processor, facilitate performance of operations, the operations comprising:
sending a floor grant message from a first group home server to a first user device of a first interworking group, wherein the first group home server controls first group call services for the first interworking group, and wherein the floor grant message grants a communication floor to the first user device;
sending a floor taken message from the first group home server to an interworking function that couples the first group home server to a second group home server that controls second group call services for a second interworking group;
receiving an interworking function message from the interworking function in response to the floor taken message;
in response to the interworking function message comprising an acknowledgment from the interworking function, facilitating a first group call communication from the first user device to a second user device of the second interworking group; and
in response to the interworking function message comprising a floor request with a high priority message from the interworking function, revoking the communication floor from the first user device.

18. The non-transitory machine-readable medium of claim 17 wherein the operations further comprise queuing, by the first group home server, a first floor request from the first user device, queuing, by the first group home server, a second floor request from a third user device of the first interworking group, and wherein the sending of the floor grant message and the sending the floor taken message occurs in response to dequeuing the first floor request.

19. The non-transitory machine-readable medium of claim 17, wherein the interworking function message comprises the floor request with a high priority message, and wherein the operations further comprise re-queuing the first floor request.

20. The non-transitory machine-readable medium of claim 17, wherein the floor taken message is a first floor taken message, wherein the interworking function message comprises the floor request with a high priority message, and wherein the operations further comprise sending a second floor taken message from the first group home server to a serving subsystem or a participating function coupled to the first group home server.
